(19) United States
(12) Patent Application Publication
(10) Pub. No.: US 2007/0027778 A1
(43) Pub. Date: Feb. 1, 2007

(54) Single electronic application for originating and controlling workflow for multiple requested products

(76) Inventors: Scott Schellhammer, Brambleton, VA (US); Joe Hallett, Mount Airy, MD (US); Ken Young, Gilbert, AZ (US); Sean Muir, Gainesville, VA (US); Glen Dennis, Ashburn, VA (US)

Correspondence Address: STAAS & HALSEY LLP, SUITE 700, 1201 NEW YORK AVENUE, N.W., WASHINGTON, DC, 20005, US

(21) Appl. No.: 11/391,347

(22) Filed: Mar. 29, 2006

Related U.S. Application Data
(60) Provisional application No. 60/666,152, filed on Mar. 29, 2005.
(60) Provisional application No. 60/666,151, filed on Mar. 29, 2005.

(51) Int. Cl. G06Q 30/00

(52) U.S. Cl. 705/26

(57) ABSTRACT

A single electronic application for requesting a plurality of different products by an applicant. The application is electronically associated with different types of information relating to the applicant. A workflow engine controls automated processing of workflow required to approve the requested products, in accordance with the information associated with the application.

### CROSS-REFERENCE TO RELATED APPLICATIONS

This application is related to and claims priority to U.S. Provisional Application Serial Number No. 60/666,152, entitled CONFIGURATION/MULTI-PRODUCT, by Scott Schellhammer et al., filed Mar. 29, 2005, and U.S. Provisional Application Serial Number No. 60/666,151, entitled PRICING ENGINE, by Laura Elmufdi et al., filed Mar. 29, 2005, the disclosures of which are incorporated herein by reference in their entirety.

### BACKGROUND OF THE INVENTION

### Description of the Related Art

Institutions such as banks, insurance agencies, brokerage houses, or government agencies may require applicants to provide information in order to receive products or services.

Applicants are often asked to provide the information in the form of an application. There is typically a different application for each service provided by an institution. In addition, separate types of institutions have traditionally offered services. A bank, for example, which offered loans has not needed to provide the infrastructure necessary in the form of information acquisition to enable the provision of stock brokerage accounts.

In the prior art, an applicant completes a different application for each different type of product or service request. For example, the entity relationship diagram in FIG. 1 shows an application 11 is completed for a product request 12 such as a request for a secured credit card. A secured credit card is linked to a bank account, allowing a credit card company to deduct payment if the cardholder fails to pay.

The secured credit card product request requires certain information during the origination process. This information includes, for example, customer name 13a, credit report 13b, disbursement 13c, stipulation 13d, collateral 13e, documents 13f, disclosures 13g, cross-sell 13h, liabilities 13i, history 13j and notes 13k. The Information is collected and used for decisioning during the origination process.

FIG. 2 shows an application 21 for a product request 22 such as a credit card which is unsecured. Unsecured credit cards are given without any guarantee of payment, performance, satisfaction or opportunity for return from the recipient. The unsecured credit card product request requires certain information during the origination process such as, for example, customer name 23a, credit report 23b, disbursement 23c, stipulation 23d, documents 23e, disclosures 23f, cross-sell 23g, liabilities 23h, history 23i and notes 23j. However, the origination process for unsecured credit card would not require collateral information.

FIG. 3 shows an application 31 for a product request 32 such as a life insurance policy. This product request requires certain information during the origination process including, for example, customer name 33a, credit report 33b, disbursement 33d, stipulation 33e, documents 33f, disclosures 33g, liabilities 33h, history 33i and notes 33j. However, it would also require a medical report 33c in order to determine whether the customer would qualify for the life insurance and what the risk level of the customer is.

As shown in FIGS. 1, 2 and 3, there is a separate application for each separate product request. Each application is linked to a different product request. Accordingly, multiple applications are required for multiple product requests. Also, the information collected for the origination of each product request is different and will vary depending on what information is needed by the origination process for each product request.

The limitations of the approach where a separate application is required for each product request are that product requests are not tied closely together, information related to the product requests cannot be shared and reused, and decisions related to the product requests are independent from one another. For example, as in FIGS. 1 and 3, if the same customer is applying for the credit card and the life insurance policy simultaneously, a credit report would need to be retrieved for the credit card application and another credit report would need to be retrieved for the life insurance policy application.

Products and services such as loans, insurance policies, investment vehicles, and licenses often require applicants to provide some similar pieces of information that are shared by all of the services, such as their name, mailing address, assets and liabilities. Other pieces of information may only be required by a subset of applications for services. A gun license, for example, may not require a credit report to obtain, but both a car loan and a mortgage application might.

### SUMMARY OF THE INVENTION

Various embodiments of the present invention provide an apparatus which includes (a) a single electronic application for requesting a plurality of different products by an applicant, the application being electronically associated with different types of information relating to the applicant; and (b) a workflow engine controlling automated processing of workflow required to approve the requested products, in accordance with the information associated with the application.

In various embodiments of the present invention, the application is electronically associated with different domain objects corresponding, respectively, to the different types of information, to thereby associate the application with the different types of information.

In various embodiments of the present invention, a user interface is provided via which a user of the interface configures or reconfigures which different products are requestable by the application, and via which the user associates different types of information with the application as required for the requested products.

In various embodiments of the present invention, the workflow engine controls automated processing of workflow so that workflow required to approve multiple requested products is performed in parallel.

In various embodiments of the present invention, a first of a plurality of different products is requested via the application at a first time, and a second of a plurality of different products is requested via the application at a second time later than the first time and after processing of workflow required to approve the first of the plurality of different products has begun.

Moreover, in various embodiments of the present invention, the application is associated with information defined by a material data set as material data for a respective requested product, and the workflow engine reroutes workflow for the respective requested product when the material data defined by the material data set is changed in the application.

In various embodiments of the present invention, a user interface is provided via which a user of the interface determines the material data set.

Further, in various embodiments of the present invention, a user interface is provided via which a user of the interface determines the material data set and determines the rerouted workflow.

In various embodiments of the present invention, the application and the information associated with the application are at different levels in an relationship hierarchy, and the information is shared during the automated processing of workflow for the different products at a level in the relationship hierarchy at which the application resides.

An addition, various embodiments of the present invention provide an apparatus which includes (a) a single electronic application for requesting a plurality of different products by an applicant, the application being electronically associated with different domain objects corresponding, respectively, to different types of information for the applicant; (b) a user interface via which a user of the interface configures or reconfigures which different products are requestable by the application, and via which the user determines which different domain objects are associated with the application; and (c) a workflow engine controlling automated processing of workflow required to approve the requested products, in accordance with the information corresponding to the domain objects associated with the application by the user via the interface.

Moreover, in various embodiments of the present invention, a product origination system includes (a) a single electronic application for applying for at least two products, each of said at least two products having data capture attributes, the application including data for a union of the data capture attributes; and (b) a processor originating said at least two products by receiving data for the data capture attributes via the application, and controlling automated workflow required to make approval decisions for said at least two products in accordance with the received data.

The above descriptions of various embodiments of the present invention are not intended to be applicable to all embodiments of the present invention, and instead represent different possible embodiments.

The above and other features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements. A more complete appreciation of the invention and many of the attendant advantages thereof will be readily obtained as the same becomes better understood by reference to the following detailed description when considered in connection with the accompanying drawings, wherein:

FIGS. 1, 2 and 3 show conventional product origination;

FIG. 4 shows an entity relationship diagram according to an embodiment of the invention;

FIG. 5 shows customers associated with an application whom are not associated to all product requests according to an embodiment of the invention;

FIG. 6 shows a system architecture for a product origination system according to an embodiment of the invention;

FIG. 7 shows an interface for use with a product origination system according to an embodiment of the invention.

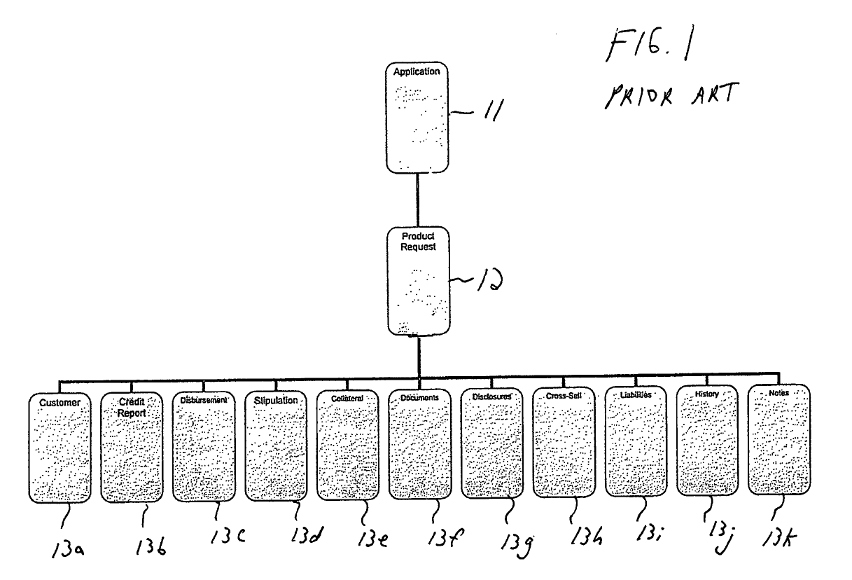

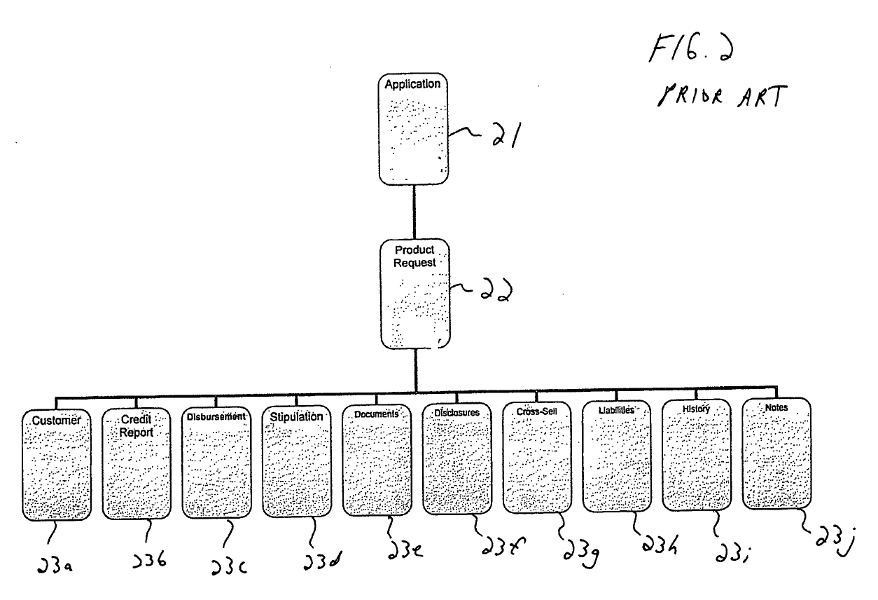

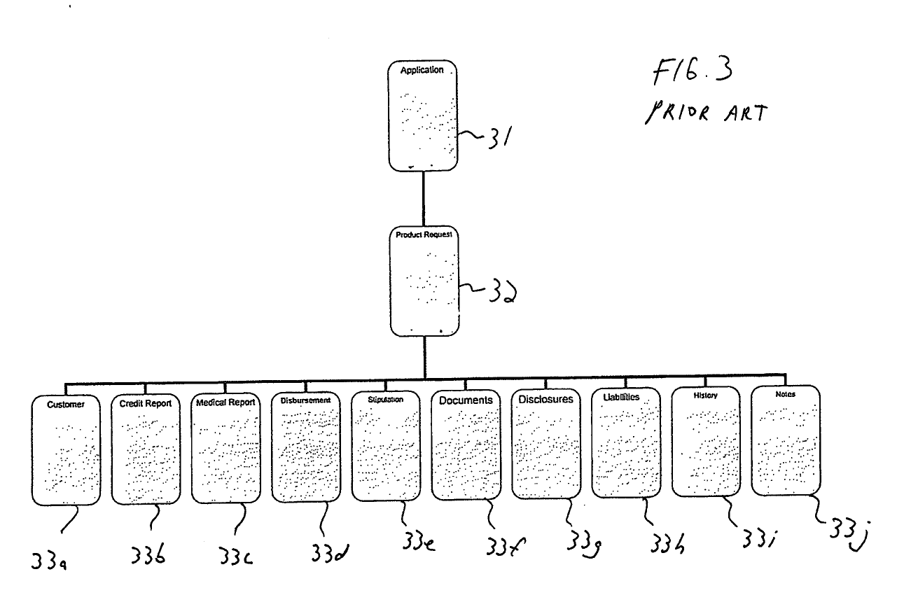

### DETAILED DESCRIPTION OF THE PREFERRED EMBODIMENTS

The present invention is a computer implemented origination system that provides flexibility in system set up and ease of system configuration. The system can be set up to originate any kind of product, including but not limited to: credit products, deposit accounts, investment accounts, insurance policies, wireless subscriptions and licenses. The system can be configured to originate multiple, different products based on one customer application, and reduce overall system costs. A company can more quickly bring new products and services to the marketplace.

Business users can configure many aspects of the system that have traditionally required technical resources. Empowering business users allows system setup tasks, that otherwise would have required custom code to be developed, to be accomplished through configuration. In addition to providing highly scalable, flexible, and powerful functionality, the architecture empowers business users to configure many aspects of the system that have traditionally required technical resources. Empowering business users allows reduction in the time to market for new product introductions.

Multi-Product/Single Application

Since different types of products and services such as loans, insurance policies, investment vehicles, and licenses often require applicants to provide some similar pieces of information that are shared by all of the applications, it would be desirable if such products and services could be originated from a single, common application. Since other pieces of information may only be required by a subset of applications for products and services, it would be desirable for similar products to be grouped by their required attributes so that a common application may be provided to apply for them.

Since a different application may be used for each products and service provided by an institution, and even if there is a common application, it may well need to be copied for use by different branches of the same institution, it would be desirable if there were a single application from which several different products and services might be originated. Also, since a standard application may contain information that is not necessary for a particular service, it would be desirable if the single application could be customized to include only the information required by a specific product or group of products.

The present invention shows a product origination system in which a plurality of different products request may be originated from a single electronic application. Furthermore, in product origination system, at least two of the product requests may be originated substantially simultaneously with the single electronic application. The single electronic application may be used to acquire data for an application for each of several different product requests.

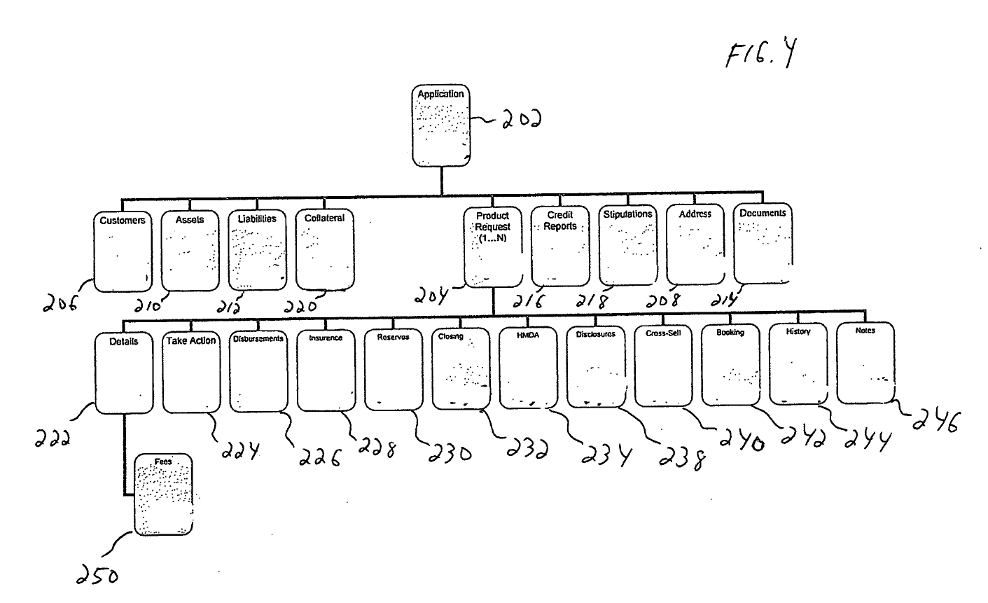

The entity relationship diagram of the present invention is shown in FIG. 4. A single electronic application 202 can be associated to one or multiple product requests 204. Further, the application 202 can collect information from one or more domain objects such as, for example, Customers 206, Addresses 208, Assets 210, Liabilities 212, Collateral 220, Documents 214, Credit Reports 216, and Stipulations 218. These are only examples of domain objects, and the present invention is not limited to these specific domain objects.

The domain objects are at the application level and can be associated with one or more product requests 204. The present invention provides for consistency of information at the application level, such as, for example, Customer 206, Asset 210, Liability 212, and Collateral 220, across Product Requests 204. Of course, this is only intended as an example of information which is maintained to be consistent at the application level, and the present invention is not limited to this example.

Referring to FIG. 4, at the product request level, each Product Request 204 can be associated with domain objects such as, for example, Details 222, Take Action 224, Disbursements 226, Insurance 228, Reserves 230, Closing 232, HMDA 234, Disclosures 238, Cross-Sell 240, Booking 242, History 244 and Notes 246. Each Detail 222 can be associated, for example, with Fees 250. These are only examples of domain objects and entity relationships, and the present invention is not limited to these specific domain objects or relationships.

Therefore, as illustrated, for example, in FIG. 4, a single electronic application is provided for requesting a plurality of different products by an applicant. The application is electronically associated with different domain objects corresponding, respectively, to different types of information for the applicant. A “single” application indicates that the application is a single application to the applicant, and is also a single application used for workflow processing of the requested products. Moreover, an “electronic” application indicates that the application is in electronic form for processing by a computer.

The present invention allows, for example, for calculations to be done at the overall application level which provides a more precise and true picture for the origination process. By having shared information at the application level, calculations across Product Requests 204 are easy and straight forward. The liability and liability behavior of the customer or customers 206 can be determined at the application level, customer level or product request level. For example, calculations such as Debt to Income ratio (DTI), Loan to Value ratio (LTV), total asset amount, total liability balance, total collateral 220, net worth, monthly payment, payment to income ratio, etc. can be computed using information for the product requests 204, the customers 206 or the application.

As an example, the present invention allows for multiple ways to calculate liabilities 212. The customer's liabilities 212 are any amounts owed to others, including, for example, short-term and long-term debts. Liabilities 212 include financial obligations such as, for example, car payments, credit card debts, student loans, judgments, collection accounts, alimony and child support. The total liability balance is the sum of all liabilities 212. The total liability balance amount at the product request level is the sum of the total liability balance amount for each customer associated with the product request. The total liability balance for the application, which can include one or more product request, include the liability balance at the product request level for the associated one or more product requests 204.

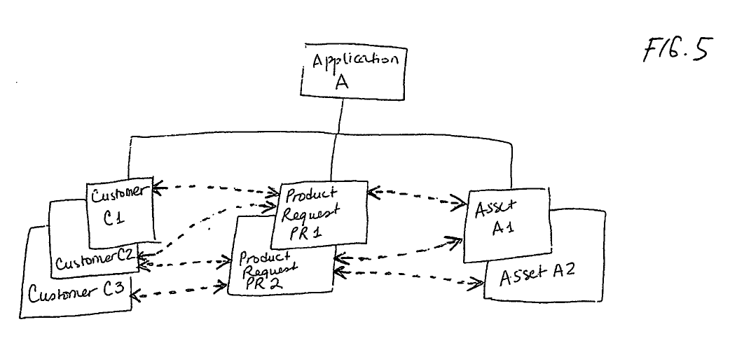

As shown in FIG. 5, the present invention allows for customers to be associated with an application but that are not associated to all product requests. For example, as shown in FIG. 5, Application A has three customers, C1, C2 and C3. Application A is associated with two product requests, PR1 and PR2. Product request PR1 has customers C1 and C2 on it and Product Request PR2 has two customers on it C2 and C3. In addition, information on assets collected for the application includes Asset A1 and A2. Product request PR1 is only interested in evaluating asset A1 and product request PR2 is interested in evaluation assets A1 and A2. The associations of product requests to other domain objects can be configured by the user.

Of course, the present invention is not limited to any particular number of customers, any particular number of applications or any particular number of product requests, or any particular relationships among these.

Although the domain objects are defined within the object model, the information or attributes collected at the application level and product request level will depend on the configuration of the products and product groups.

Product and Product Groups

Products and Product groups are defined by the business needs. Products are defined to the product origination system by the business users. The products could be, for example, a license, such as a gun license, a hunting license, a private investigator license, an exterminator license, a hairdresser license, a real estate license, a fishing license, or a dog license. The products could also be a financial product, such as a credit product, like a loan, a deposit account, or an investment account. Finally, the products could be commercial product such as an insurance policy or a wireless subscription. The products are not limited to these examples, rather, they are meant to be purely exemplary, and amenable to variation by persons skilled in the art, within the scope of the invention.

Products can be grouped together under product groups. A group of products might share common data elements or attributes, such as collateral information, medical records or criminal records. Two products, such as home equity line of credit and home mortgage, might be likely to share collateral information. Products need not be organized into groups, organizing products into groups, rather, is a convenient method of organizing common products. Product Group is way to group products based on common characteristics. Product Groups may have many associated products.

A Product inherits and extends all common product features and attributes defined at a group level. A Product inherits Attributes, Data Capture Sets, Required Data Sets, and Validators from its parent Product Group. Product definitions allow refinement of primary products defined at the group level.

Configuration

The configurable architecture empowers system administrators and business users to determine many aspects of the product origination system. The configuration of the product origination system includes, for example:

Extension of the object model to determine what domain objects, data elements or attribute to collect at the application and product request level;

Creation and definition of products and product groups to meet business requirements;

Configuration of the product origination user interface;

Creation and modification of workflow processes and routing based on products and product groups

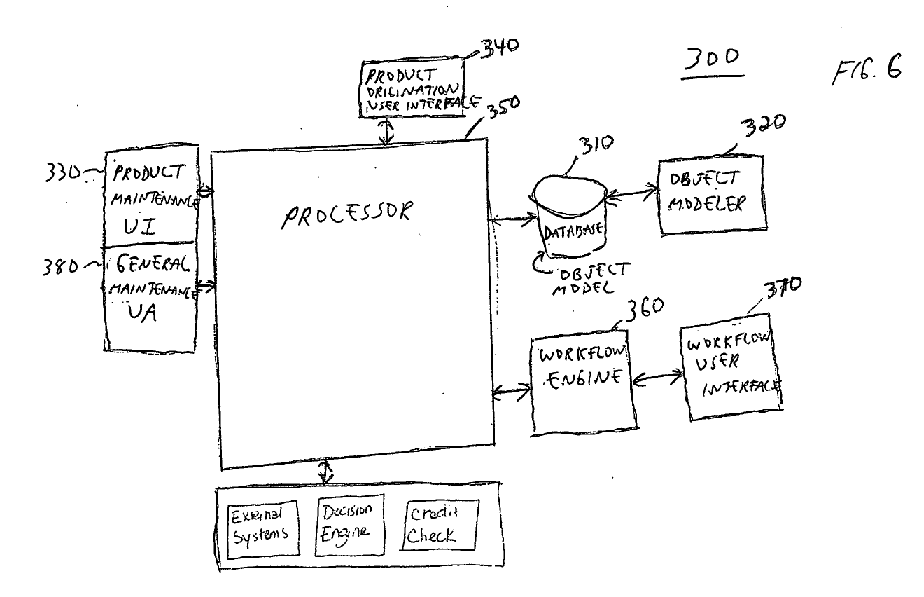

FIG. 6 shows an example of a system architecture of a product origination system 300, according to an embodiment of the present invention.

Referring now to FIG. 6, the database 310 contains data for the product origination system and an object model 310 used for the product origination system. The product origination system object model 310 is governed, for example, by XML, called Domain XML, which is used to automatically generate the requisite code for the persistence layer and database schema. However, the present invention is not limited to the use of XML or Domain XML. Modifications to the domain objects are achieved, for example, through use of a object modeler tool 320, such as, for example, Rational XDE. However, the present invention is not limited to the use of Rational XDE. The object model 310 can be extended by a system administrator to add or remove domain objects and/or attributes at the application level and/or the product request level as defined by the business need. In embodiments of the present invention, the domain objects within the object model are configurable. Configuration of the data by allowing business users to define the information to collect, called attributes at each level. What attributes to collect are configured by the user for each product type. The present invention empowers system administrators to configure the information to collect at the application and product request level. Further, the product origination system allows configuration of data captured for each type of product.

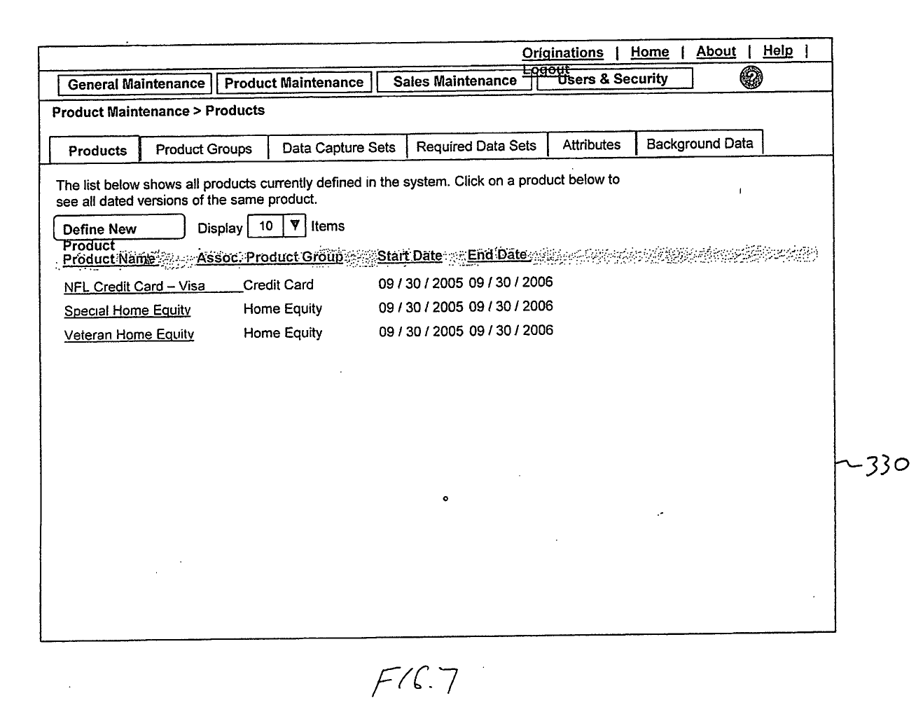

After the domain objects and attributes have been defined, the business user can create and modify products and product groups via the Product Maintenance user interface 330, shown in FIG. 7. Of course, the present invention is not limited to the specific example of a Product Maintenance user interface 330 as shown in FIG. 7. The attributes are grouped into data capture attribute sets which “filter” what should be displayed on the product origination user interface 340. The product origination user interface 340 is used by users to create applications, product requests for customers and work to originate the products.

The data capture attribute sets are configured by the business administrator user and are independent—they can be configured to be associated with product groups or products. For example, some products may not require a collateral object (domain) so the product origination user interface screen related to collateral will not be displayed. Likewise, a product could be configured to display the customer page but the middle initial (for example) could be configured to not display. This would be done by creating a data capture attribute set for applicants where the middle initial is not included, and then associating this particular data capture attribute set to this product. Then, the product origination user interface is intelligent to review the data capture attribute sets for one or more product requests (i.e., multi-product) on an application and display the appropriate fields for data entry in a manner efficient for the user.

The General Maintenance user interface 380 allow users to maintain other types of data related to application and product request level such as reference data, disclosures, stipulations, fraud cases, reports, review lists, insurance types, providers, agents, and reserves.

Configuration of the product origination system user interface 340 can be achieved by manipulation of data capture attribute sets, required for save sets, required for submit sets, and other configuration settings. For example, the system administrator can change field labels, remove existing fields and add new fields. The details of these configuration types will be described below.

Product origination user interface 340 can be generated using a Processor 350 which takes as input the domain objects from the object model 310 and combine or marry that with the data capture attribute sets to determine what fields are needed on any product origination user interface. The processor 350 would, for example, leverage or integrate a tool like, for example, the CGI-AMS Framework or Apache Struts to generate the user interfaces. If a new product origination user interface screen 340 is needed, the Processor allows straightforward creation of new screens based on the creation of new domain objects in the object model. This data driven approach to screen development and configuration eliminates the need to develop raw code to create these screens.

As discussed above, the product origination system architecture provides the ability to configure data capture attribute sets for products and product groups. The Processor 350 uses these data capture attribute sets to dynamically determine which data to display on the product origination user interface 340 based on the specified product request. By using the Processor, the product origination system enables Business Administrators to configure which fields are to be displayed and required for save/submit on the product origination user interface 340. The product origination system 300 achieves this level of configuration by allowing business users to select from a library of attributes for a given screen. Since data capture attribute sets can be configured at the product level, Business Administrators can define which fields to display and which fields are required for save/submit for different products.

Workflow

As shown in FIG. 6, the product origination system is integrated with a Workflow engine 360, such as, for example, FileNet P8, to provide workflow capabilities. However, the present invention is not limited to any particular workflow engine. The present invention leverages a workflow engine to provide control over the order, applicability and priority of the product fulfillment steps, as well as the gathering of internal and external data.

Workflow engine 360 allows for automation of procedures by using a set of rules to define where documents, information, or tasks are sent. These rules are designed to achieve or contribute to an overall business goal.

The processing flow or workflow within the product origination system can be configured for each product. The present invention allows for product requests to move through workflow separately or tied together.

The association of workflow within the product origination system can, for example, be made at the product or product group level, allowing the selection of one workflow for the product or product group. In addition some of the other definitions described in this section (like Material Data Sets and Required Data Sets) will affect workflow execution.

Business users can easily define workflow and routing rules using, for example, a workflow user interface 370. The workflow engine provides, for example, the ability to configure the following items, although the present invention is not limited to these items being configured:

Process Definition—Defines the business steps required to complete a particular business process (e.g. Home Equity Loan Origination).

Work Item Definition—Defines the data that will be used for routing decisions.

Action status transitions—Defines the points where status for a product request change. This is a part of the process definition.

Users interact with the product origination system workflow when it routes a product request to a queue for manual investigation and intervention, such as a need to review credit report data or make an approval/decline decision.

Tasks

Within the workflow, a task is denoted as a point in the workflow process where manual user intervention is needed. Various task distribution methods are available as well as various statuses (such as Active, Inactive, Pended, and Completed).

Task due dates are assigned based on the task to be done. Escalation logic allows for tasks to be sent to another user (such as a supervisor) or another queue.

Queues are like a “bucket” containing tasks that users can get work from via queue worklists and get-next.

It should be understood that the system architecture in FIG. 6 is only one particular example of an appropriate architecture, and many variations are possible. For example, FIG. 6 shows various different user interfaces. Various of these interfaces can be presented to a user together as a single interface. There are many other possible variations of the system architecture in FIG. 6, and embodiments of the present invention are not limited to the specific embodiment in FIG. 6.

Parallel Workflow

Referring back to FIG. 5, each product request (e.g. Product Request PR1, PR2) can have its own workflow. Each product request is going through different workflow paths at the same time under the same application (e.g. Application A). The parallel workflow within product origination system enables parallel processing of workflow steps or tasks for a given application's product request, such that the multiple workflow steps for a single product request can be processed concurrently

A product request may require parallel workflows when the workflow map branches. For example, a product request may have multiple active stipulations, each having its own workflow.

In addition, workflow can be controlled by workflow engine 360 so that, for example, different products can be applied for at different times via the same application. For example, a first product might be requested by an applicant via a single electronic application at a first time, and a second product might be requested via the same application at a second time later than the first time and after processing of workflow required to approve the first product has begun. Workflow engine 260 controls the workflow for both the first and second products.

The product origination system allows, for example, for changes, terminations, turn downs, and withdraws of a product request across multiple workflows. This allows the changes to be considered across all other streams in which the product request is being processed. For terminations, withdraws, or turndowns, the product origination system will remove tasks for that request in other streams and end processing of the request in those streams.

For material data changes, the product origination system considers the impact of that material data change in all other streams in which the product request is being processed, and route the request accordingly.

The product origination system reflects the impact of parallel workflow within the product origination user interface 340. Each separate occurrence of product request/workflow stream is treated as a separate task.

Product Configuration

The building blocks of product configuration are attributes and data capture attribute sets. Attributes are defined, for example, in the object model domain XML, with each object domain defining a particular list of attributes. A particular class of data, such as the names of all applicants, is termed an attribute. Attributes are the building blocks of single electronic application

Attributes within these object domains can be combined to create data capture attribute sets.

Data capture attribute sets are configured using the Product Maintenance user interface. Once attribute sets have been defined, they can be assigned to products as part of product data configuration. Any attributes in a product data capture attribute set will drive the display of data fields on the product origination application User Interface. These sets are normally associated at the product group level, but can also be specified at the product detail level as an addition to those at the group level. The assignment of data capture sets is performed via the product maintenance user interface.

The Product Maintenance user interface is used to enter product details into the product origination system. Tasks include setting up and establishing products and the product groups that can contain a grouping of product types. The Product Maintenance user interface enables the System Administrator to make system entries to define and maintain, for example, the following items, although the present invention is not limited to these items:

Products—Create and maintain product configurations and their effective dated versions. By configuring a product version, the user defines the amount of information that product Originations user Interface users need to enter for a product request on an application.

Product Groups—Create and maintain products groups. Product groups are categories of related products. Characteristics defined for a product group are inherited by all products associated to that group. Product groups the user creates are available for product Originations user Interface users.

Data Capture Sets—Create, update and delete Data Capture Sets. A data capture set defines the fields that are displayed in product origination system related user interface screens, and the types of data that need to be entered for product Originations user Interface users working with product requests. For example, data capture sets enable System Administrators to specify the number of fields that appear on an product Originations user interface screen by choosing to show or hide specific fields. The attributes (data items or pieces of information) the user selects here correspond to fields, drop-down lists, check boxes, . . . etc. that appear in product origination system screens.

The user can enter or update information for a data capture set, with which product origination user interface screens are associated. The data capture set definition can include the name of the data capture set, and the domain and attributes associated with it. Data capture sets, which can be added to version configurations of products and product groups, define the data that can be entered for a product request initiated by a product Originations Interface user.

Products that belong to a group will probably share a common set of data capture attribute sets. Data capture attribute sets are normally associated with the products at the group level, but can also be specified at the products detail level as an addition to those at the group level. The single electronic application includes data sufficient to provide for a union of the data capture attribute sets that have been defined for each of the products for which application is to be made.

The product origination system allows for a single application with multiple product requests, each product request associated with data capture attribute sets. A single application is provided for multiple products including a union dataset comprised of a union of the data capture attribute sets. The reason the single application is comprised of a union of the data capture attribute sets is to ensure that all of the information necessary for the products, as defined by the data capture attribute sets, is available, but none is duplicated. There is no need, for example, to acquire a mailing address of the applicant more than once, even though several products, all specifying a mailing address, may be originated from the single application. At least one instance of any data that is unique to a product, on the other hand, ought to be included in the single electronic application.

For example, attributes designated as data capture attributes by both a product request for a mortgage and a product request for a credit card will need to be designated as data capture attribute sets on the single electronic application only once. When the electronic application is made for the mortgage product request mortgage or credit card product request, or both, data will have been collected and will be available to both. For every instance in which attributes that are unique to either mortgage product request or credit card product request, the attributes will need to be designated as separate data capture attribute sets that would be associated to either the mortgage product or credit card product. The attributes represented as data capture attribute sets on the single electronic application will thus form a union of the data necessary to apply for a mortgage product request and a credit card product request, including data which are collected for each product request and data which are shared by both product request. Both credit card and mortgage product requests may thus be originated from the single electronic application.

For each product and product group, data capture attribute sets can be selected for particular domain object. Attributes in a chosen data capture attribute set drive the display of data fields on the product origination system User Interface. Product data defined at the product group level refers to attribute sets specific to that product group. Moreover, product data defined at the product level is unique to that product, and if different than that of its associated product group, supersedes the data capture attribute set defined at the product group level. Business Administration Specialists can assign Product Data to products and product groups via the Product Maintenance user interface.

Required Data Sets

Once data capture attribute sets have been defined, they can be assigned to products as part of required data set configuration via the product maintenance user interface. Any data in a required data set is required to be entered as a prerequisite to application and product request submission. A required data set defines the application details that must be specified before further action can be taken by product Originations Interface users working with product requests.

For continuation through the workflow, there are several required data set definitions for each product group.

Required for Save

Attributes sets can be specified, for example, as Required for Save. Attributes within required for save attribute sets must have a value before a product request can be saved to the system. When a user attempts to save, or submit for processing, a product request that does not have all the required for save attributes, the system issues an error message.

Required for Submit

Attribute sets can be specified, for example, as Required for Submit. Attributes within a Required for Submit attribute set must have a value before a product request can be submitted for processing. When a user attempts to submit a product request that does not have all the required for submit attributes, the system issues an error message.

Required for Closing

Attribute sets can be specified, for example, as Required for Closing. Attributes within a Required for Closing attribute set must have a value before a product request can complete any closing step in its workflow.

Required for Booking

Attribute sets can be specified, for example, as Required for Booking. Attributes in a Required for Booking attribute set must have a value before a product request can complete any booking step in its workflow (that is, before the product origination system can send information about a completed originations request to an external system that handles accounting or servicing for the request).

Required for Funding

Attribute sets can be specified, for example, as Required for Funding. Attributes in a Required for Funding attribute set must have a value before a product request can complete any funding step in its workflow (that is, before the product origination system can send information about a completed originations request to an external system that disburses funds to the customer or other designated payees).

Background Data

Outside of the data model domain XML, unique attributes shared across many products and product groups can be defined via the Product Maintenance user interface. These attributes, together with their assigned values, combine to form a distinctive set of background data. Examples of background data are financial terms, such as margin, cap, max term, or system configuration parameters, such as workflow map ID, or BureauLink profile. A product background attribute is defined one time, but can have multiple values associated with it. When background data is then associated with a product group or a product, the user selects the attribute/value combination desired. All definition and association is performed via the product maintenance user interface.

A background data attribute is a data item or a piece of information that does not currently exist in the system, which can be used to store additional information for a product or product group version. For example, method of payment calculation, limits on pricing, or minimum income amount required. Background data values can be specific to an organization that will augment the attribute data.

Promotional Products

A promotional product is an umbrella term that includes companion and ancillary products. Companion products are “decisionable” products that are associated with another product. In contrast, ancillary products are “non-decisionable” products associated with another product. Both companion and ancillary products can be applied for in addition to the original product request. A Business Administration Specialist can assign promotional products to products and product groups via the Product Maintenance user interface.

Validators

Validations can consist of two different forms. The first is attribute set validations. Attribute sets are created using the reference data maintenance screens, and consist of a name, type, description, and a configurable group of attributes. In order to pass an attribute set validation all attributes that comprise that set must be of correct type on the product request.

The second type of validation is the Category 2 Data Validators. These category 2 data validators are pieces of code, that when run, will ensure consistency of data for a product request and perform multiple attribute validation or cross-validation. Category 2 Data Validators are executed upon submission of a product request and on every save post submission.

An example of a Category 2 Data validator is a validation test, such as checking that applicant age and date of birth are in sync. Category 2 data validators can be any parameterized business logic. Validators can also be built to accept parameters, such as a test for accounting system feed fields.

Category 2 validators are assigned to products and product groups via the product maintenance user interface, where a specific parameter value can be associated with the validator.

The workflow can also then be configured to execute validations, these are known as dynamic validators. At any point in the workflow process an “executeValidators” business service can be called, which will run an attribute set and/or a category two data validator. The service will accept the names of the validators as parameters, so that it can dynamically run any set of validations. The workflow will be configured to execute the appropriate validators at each stage, and can then route appropriately based on the success or failure of the validators. The dynamic validators can also be configured to trigger upon a task completion within workflow. An example of a dynamic validator is to check all data needed before disbursing funds.

Material Data Sets

During application processing in product origination system, users have the opportunity to change data captured earlier, if corrections or updates are needed. Ideally, if the data changed is relevant to the decision to accept/decline the product request, or other processing that may already have been performed on the request, it would be desirable to re-perform that processing on the request using the changed data values. The product origination system provides the ability to define attribute sets as material data sets. A material data set is a logical grouping of fields/attributes pertinent to a particular system task in the product origination process. If any one piece of data in the set were to change, workflow should route back to some step in workflow. The material data can be linked to workflow processing such that, when the system detects changes to the data in the material data sets, it will move the request to the proper point in the workflow and re-process the request.

For example, a change in an Address material data set, consisting of street name, state, and ZIP code, could re-route the request back to retrieve a new credit bureau report. Material data set definition and association is at the product group level and is done via the product maintenance user interface.

For each product or product group, a set of material data sets can be defined. Once defined these material data sets can be used to trigger actions in the workflow process. Material data sets and the attributes within the material data sets are configurable within the Product Configuration User Interface.

For example, the following is a list of the material data sets, although the present invention is not limited to these material data sets:

Price Material Attributes (e.g. include rate, term, loan amount, customer tier, . . . ) are attributes which would control the pricing strategy and would affect the price if the attribute changed

Prescreen Material Attributes (e.g. include birthdate, age, income level, time with employer, . . . ) are attributes which affect whether the product origination system would want to extend a product offer to a customer

Duplicate Check Material Attributes

Fraud Check Material Attributes

Credit Report Material Attributes—would include attribute such as address so if address changes, it would trigger a processing step within workflow related to credit report.

Custom Score Material Attributes

Stipulations (Initial) Material Attributes

Stipulations (Pre-Decision) Material Attributes

Decision Material Attributes

Life Insurance Prescreen Attributes—(e.g. age, lifestyle habits, smoker) are some attributes that would affect whether a life insurance product offer would be extended to the customer.

To determine which systems tasks in the product origination process must be re-run, the system will evaluate the data that has changed against the material data sets for each previous system task in the process.

Table 1 below summarizes the priority for material data sets based on product group. For example, if the product group is credit card and data changes while in the Credit Report Investigation Task, the system evaluates all material data from previous system tasks and determines if any material attribute sets are affected. In this example, the system evaluates the Credit Card material data sets 1-thru 4. If the system determines that data from sets 3 and 4 were both changed, Workflow Engine will be informed of both material attribute sets. The workflow map, handling priority by the order in which each route/path is set up, will be configured such that, since set 3 has higher priority, the system re-routes to system task 3 and re-processes the Fraud system task.

TABLE 1

| Credit Card | | Home Equity | | First Mortgage | |
|---|---|---|---|---|---|
| 1. | Prescreen Material | 1. | Stipulations (Initial) | 1. | Price Material |
| | Attributes | | Material Attributes | | Attributes |
| 2. | Duplicate Check | 2. | Prescreen Material | 2. | Stipulations (Pre- |
| | Material Attributes | | Attributes | | decision) Material |
| 3. | Fraud Check Material | 3. | Duplicate Check | | Attributes |
| | Attributes | | Material Attributes | 3. | Prescreen Material |
| 4. | Credit Report Material | 4. | Fraud Check Material | | Attributes |
| | Attributes | | Attributes | 4. | Duplicate Check |
| 5. | Credit Liability Prefill | 5. | Credit Report Material | | Material Attributes |
| 6. | Custom Score | | Attributes | 5. | Fraud Check Material |
| | Material Attributes | 6. | Credit Liability Prefill | | Attributes |
| 7. | Price Material | 7. | Custom Score Material | 6. | Credit Report Material |
| | Attributes | | Attributes | | Attributes |
| 8. | Loan/Line Amount | 8. | Loan/Line Amount | 7. | Credit Liability Prefill |
| | Material Attributes | | Material Attributes | 8. | Custom Score Material |
| 9. | Stipulations (Initial) | 9. | Price Material Attributes | | Attributes |
| | Material Attributes | 10. | Stipulations (Decision) | 9. | Pre-Decision |
| 10. | Decision Material | | Material Attributes | | Stipulations Material |
| | Attributes | 11. | Policy Exception | | Attributes |
| | | | Material Attributes | 10. | Decision Material |
| | | 12. | Pre-Decision | | Attributes |
| | | | Stipulations Material | | |
| | | | Attributes | | |
| | | 13. | Decision Material | | |
| | | | Attributes | | |

Stipulations

Stipulations are tasks which require sending to and/or receiving certain documents (e.g., Survey, Verification of Employment) from parties involved in the lending process. These documents may simply be notices that must be sent out as dictated by law. Other documents are sent with an expectation that something will be returned, such as a signature or more information. For turnaround stipulations, a document is returned from the receiver to the lender, and the status of its corresponding stipulation is updated to reflect this. This document is then verified for acceptance, followed by another stipulation status update, completing the stipulation workflow.

The product origination system user interface allows for lists of all the outbound documents generated for, and turnaround documents to be associated to the stipulation. Outbound documents are information that the product origination system sends out to a customer and turnaround documents are information that the product origination system requests for a customer to send back. An example of an outbound stipulation would be an approval letter sent from the product origination system to the customer. An example of a turnaround stipulation would be a document which is needed by the product origination system from the customer such as a payroll stub. Outbound documents are presented with their generation date and inbound documents are presented with their receipt date. The user can select a document from the list and see the image of the document. Stipulations can be manually created for a product request or may be systematically assigned based on attributes of the product request or application.

Versioning

Furthermore, both product groups and products can be versioned, using effective dates or other parameter. Through versioning, different combinations of product configurations can be active at different times. The different versions can have different required data sets, data capture sets, background data, complex data validators, etc. or any configuration defined at the product or product group. Because there can be different product or product group versions, each product or product group can be associated with different data capture attributes. The product origination user interface will vary according to the product or product group version within the application. Thus, the application collected for the product request will vary according to the product or product group versions.

For example, a Product Version could contain Effective Dates, Background Data, Product Data (Data Capture Sets), Validators, Ancillary Products, Tolerances. A product version is not limited to only having this data. A Product Group Version is the primary means of defining products. A Product Group Version contains Effective Dates, Background Data, Required Data, Product Data (Data Capture Sets), Validators, Wizard Order, Ancillary Products, Companion Products.

Review List

Review lists are checklist items and provide a flexible mechanism to define, work, secure, and manage a list of items in connection with a product request. The items on the review list can serve a variety of purposes. Review lists can be manually created for a product request or may be systematically assigned based on attributes of the product request or application. Review list items can be organized by categories, examples of which are initial, post-decisioning, and contract tolerance. If the conditions defined in the rules engine are met, an initial, post-decision or contract tolerance review list item is generated and added to the product request. Initial review list items are often created to help the user decide whether or not a product request should continue on to decisioning. Post-decisioning review list items are often used to draw attention to areas that may have been missed as part of the decisioning process. Contract tolerance review list items are generated when there appears to be discrepancies between the contract and policy details. The type and at what point in time review list items are generated are completely configurable

For example, if a contract terms validation against the decisioned terms is configured in the workflow, and the validation finds that one or more contract terms are out of the defined tolerance, the system could create one or more review list items for a user to check before the product request can be completed. Review list items can be added to a request by any process in workflow. Review list items are defined via the general maintenance user interface. The definition includes a specification of the point in processing by which the item must be resolved, and an expected disposition (yes or no); if a user records a disposition other than that expected, the user must specify a reason for that disposition.

Snapshot/Tolerance

The product origination system can be configured to capture “snapshots” of product terms at various points in the workflow or product request processing. For example, there could be a “requested terms” snapshot to capture what the customer applied for, a “policy terms” snapshot that reflects what automated decisioning used, and a “decisioned terms” snapshot that shows the terms that were approved by a user. The product origination system allows tolerance checks between any two terms-snapshots, or a terms-snapshot and the current working terms, for a single product request.

Snapshot check is performed based on how they are configured in the workflow process. Review list items can be created if two snapshots are compared using a tolerance and there are any items that are out of tolerance.

The product origination system may also include a tolerance. The tolerance indicates a range of acceptable variation for the data collected to the attributes. Data collected for the products could be compared to the tolerance terms to see if it is out of the acceptable range. Attributes may also be compared to tolerances while the products are being originated, to ensure that the data that will be required is acceptable.

Tolerance definitions are identified by a unique name and contain a set of high/low amount or percentage tolerances for the attributes. They are defined via the general maintenance user interface. At any point in the workflow, the attribute or attributes data values can be compared to the tolerance definitions. A comparison of terms can be configured to occur to determine if the terms being compared are out of tolerance. If they are out of tolerance, one or more review list items can be created for a user to address.

Tolerance Checking limits the level of change, or the variance, that can be made to product terms. A Tolerance definition consists of a specification of one or more attributes from the product terms, with tolerance limits (absolute and/or percentage) up or down. The creation of a review list item is specified if the term is changed beyond the tolerance limit. The tolerance check is configured in the workflow engine, and any out-of-tolerance terms changes trigger the creation of the corresponding review list item.

Examples of how tolerance checks may be used include policy exceptions and contract validation. Policy exceptions are user or product tolerance checks that compare working terms and policy terms. An underwriter may have the authority to adjust terms within parameters defined by a tolerance profile. The policy exception check determines if any adjustments made violate this tolerance profile. Contract validation compares working terms with contract terms after settlement. For example, first mortgage products generally have a zero tolerance.

The following are examples of the types of tolerance checking that occur in product origination system.

Product Tolerance Check

User Tolerance Check

Tolerances are configurable, viewable, and editable in product origination system through the General Maintenance user interface 380.

The product tolerance check occurs at configured points in workflow. Policy Terms is a terms object that contains the data returned by the Pricing Engine and/or the decision engine calls that return pricing data such as line limit. This terms object is used to calculate all terms tolerance checks. For example, the decision engine rules ensure that the working terms fall within a given variance from the policy terms. User-initiated changes to the working terms are also checked against the policy terms to ensure that users are making changes that fall within their preset limits.

There is a one-to-one relationship between a product request and both Working and Policy terms. All other terms relationships are modeled as one-to-many relationship.

Working Terms are the editable terms for a product request, that is the user modified terms. All terms snapshots are snapshots of the current working terms and are defined by the workflow. Terms comparison is always be between working terms and policy terms. The product origination system baseline service provides, for example, variances for the following terms attributes, although the present invention is not limited to these examples.

Rate

Term

Amount

Margin

The Reset Working Terms button on the Product tab calls a service that copies the Policy Terms into the Working Terms. The tab also retrieves the terms list and the terms from both the one-to-many product request to terms relationship, as well as the one-to-one terms relationships.

The User Tolerance functionality provides the ability to create a tolerance profile for each user or class of user. These tolerances may be applied for each user or class of users to selected products or product groups. This flexibility in defining User Tolerance enables an organization to have control over variances to product terms.

A Tolerance definition can be associated with a Security Application Right and a Role to define tolerance limits for a product group or product for the user assigned to that role. For additional flexibility, the user Profile can have Tolerance definitions associated with specific products. Tolerance definitions specified directly for a profile override any Tolerance definition associated with the product's Application Rights for the user's Role. The User Tolerance check is distinct from the tolerance checks built in the workflow based on product-level definitions.

On Role Maintenance, on the Associated Application Rights tab, the product origination system enables the association of a tolerance definition with the Application Right. This allows different tolerance definitions for the same product group or product for different Roles. Therefore, only one Application Right is associated with a Role.

In Profile Maintenance, on the Product Associations tab, tolerance definitions can be associated with specific products for that Profile. When checking tolerance for user terms changes, the Profile-level tolerance definition associated with a product, if one exists, is used instead of the tolerance definition at the Role level (through the Application Rights defined for that Role). If a product association is made for a Profile without a tolerance definition, this indicates that there is no tolerance in effect for the product for that Profile, and no terms changes may be made by the user.

When the user saves an application, the product origination system applies the appropriate tolerance definition (profile or role), comparing the policy terms to the working terms for the product request. For each product request on the application, the product origination system will determine if the user's profile has a specific profile-level product association for the product. If so, the product origination system performs the tolerance check with the tolerance definition associated with the product at the profile level. However, if the product association exists for the profile, but no tolerance definition has been associated with it, then no tolerance check will be made.

If no profile-level product association exists, the product origination system uses the tolerance definition associated with the Application Right appropriate for the product as defined for the user's Role (through the user's Profile). If there is no tolerance definition, then there is no tolerance for terms changes; that is, any terms changes made by the user are out of tolerance.

When terms changes are out of tolerance according to the tolerance definition used, the product origination system issues an error and the application is not saved.

Application Status

The application status is a broad, high-level description of an application's condition which is set in regards to the status of its product requests within the workflow process. The product origination system allows for an application can have two statuses, either Active or Inactive. However, the product configuration allows the values to be configurable and other status values can be added.

The application status is marked as active when the first product request on a new application is created and saved. The application maintains the active status when at least one of its product requests is in workflow. In all other cases an application will have a status of inactive; specifically when all product requests are no longer in workflow.

Workflow controls the status of the application and also sets the application status to Inactive after all product requests under that application have been processed. The status of the application is dependent on the status of that application's child product requests.

Applications are inactive when the product requests related to that application have moved to a terminal workflow state, or when there is no business workflow process remaining on any of the product requests that make up that application. The inactive status indicates the workflow processes for the one or more product requests related to the application have all been completed or fulfilled. Applications are updated to the Inactive status when all product requests have been completed, or meet requirements which represents the end of the product request workflow. When the status of an application is inactive the user is not allowed to add a new product request or edit any data on the application. Applications that have an inactive status are stored in the database in the same manner as applications in an active status. This allows inactive applications to be accessed real-time.

Additionally, when an application moves to the inactive status, the associated credit Bureau data is archived. The credit bureau data is stored in the product origination database in its entirety.

Viewing of inactive applications is allowed and can be base on each user based on his/her responsibilities or user profile.

Accordingly, embodiments of the present invention provide a system and method of product origination and configuration in which multiple products, which can be configured to suit various purposes, can be originated from a single electronic application.

Moreover, embodiments of the present invention provide a single software program originating a plurality of different types of products for which an applicant applies, and in which the originating includes controlling automated processing of workflow required to approve the products for which the applicant applies.

Further, embodiments of the present invention provide a product origination system that includes a single electronic application for applying for at least two products, each of the products having a dataset of required attributes and the single electronic application having data capture attributes corresponding to the datasets of required attributes, in which the at least two products are originated by receiving data for the data capture attributes by a processor and electronically providing the received data to the datasets of required attributes of the at least two products.

In addition, embodiments of the present invention provide an apparatus and method of originating multiple products. More specifically, a plurality of products are provided, each of the products having a dataset of required attributes. An application is also provided, and has data capture attributes corresponding to each of the datasets of required attributes. At least two of the products are originated by receiving data for the data capture attributes corresponding to the datasets of required attributes for the at least two products. The received data are provided to the datasets of required attributes for each of the at least two products.

Various processes are described herein as being “automated”. “Automated” indicates that the processes are performed by a computer in an automated manner.

Embodiments of the present invention also provide a product configuration system that includes an initial product having a initial dataset of required attributes, a final product having a final dataset of required attributes, a single electronic application from which the final product may be applied for. The single electronic application includes data for the final required attribute dataset. A processor configures the initial product into the final product by replacing the initial dataset of required attributes with the final dataset of required attributes.

Embodiments of the present invention further provide a method and apparatus of configuring products. An initial product having a initial dataset of required attributes is provided. A final product having a final dataset of required attributes is also provided. A single electronic application is provided, from which the final products may be applied for. The single electronic application includes data for the final required attribute datasets. The initial product is configured into the final product by replacing the initial dataset of required attributes with the final dataset of required attributes.

In embodiments of the present invention, for material data changes, the product origination system considers the impact of that material data change in all other streams in which the product request is being processed, and routes the request accordingly.

Various software protocols, such as, for example, XML, have been described herein. However, the present invention is not limited to any specific software protocols.

The foregoing has described the principles, embodiments, and modes of operation of the present invention. However, the invention should not be construed as being limited to the particular embodiments described above, as they should be regarded as being illustrative and not restrictive. It should be appreciated that variations may be made in those embodiments by those skilled in the art without departing from the scope of the present invention.

What is claimed is:

1. An apparatus comprising:
a single electronic application for requesting a plurality of different products by an applicant, the application being electronically associated with different types of information relating to the applicant; and
a workflow engine controlling automated processing of workflow required to approve the requested products, in accordance with the information associated with the application.

2. An apparatus as in claim 1, wherein the application is electronically associated with different domain objects corresponding, respectively, to the different types of information, to thereby associate the application with the different types of information.

3. An apparatus as in claim 1, further comprising:
a user interface via which a user of the interface configures or reconfigures which different products are requestable by the application, and via which the user associates different types of information with the application as required for the requested products.

4. An apparatus as in claim 1, wherein the workflow engine controls automated processing of workflow so that workflow required to approve multiple requested products is performed in parallel.

5. An apparatus as in claim 1, wherein a first of the plurality of different products is requested via the application at a first time, and a second of the plurality of different products is requested via the application at a second time later than the first time and after processing of workflow required to approve the first of the plurality of different products has begun.

6. An apparatus as in claim 3, wherein the application is electronically associated with different domain objects corresponding, respectively, to the different types of information, to thereby associate the application with the different types of information.

7. An apparatus as in claim 1, wherein the application is associated with information defined by a material data set as material data for a respective requested product, and the workflow engine reroutes workflow for the respective requested product when the material data defined by the material data set is changed in the application.

8. An apparatus as in claim 7, further comprising:
a user interface via which a user of the interface determines the material data set.

9. An apparatus as in claim 7, further comprising:
a user interface via which a user of the interface determines the material data set and determines the rerouted workflow.

10. An apparatus as in claim 1, wherein the application and the information associated with the application are at different levels in an relationship hierarchy, and the information is shared during the automated processing of workflow for the different products at a level in the relationship hierarchy at which the application resides.

11. An apparatus comprising:
a single electronic application for requesting a plurality of different products by an applicant, the application being electronically associated with different domain objects corresponding, respectively, to different types of information for the applicant;
a user interface via which a user of the interface configures or reconfigures which different products are requestable by the application [should this be applicant or application], and via which the user determines which different domain objects are associated with the application; and
a workflow engine controlling automated processing of workflow required to approve the requested products, in accordance with the information corresponding to the domain objects associated with the application by the user via the interface.

12. A product origination system comprising:
a single electronic application for applying for at least two products, each of said at least two products having data capture attributes, the application including data for a union of the data capture attributes; and
a processor originating said at least two products by receiving data for the data capture attributes via the application, and controlling automated workflow required to make approval decisions for said at least two products in accordance with the received data.

13. A product origination system as in claim 12, wherein
a material dataset is linked to the workflow and indicates material data included in the data for the union of the data capture attributes, and
the processor automatically reroutes the workflow when the material data is changed.

14. A product origination system as in claim 12, wherein
one of said at least two products comprises a validator, and
the validator is executed upon submission of the application to validate a data capture attribute as a prerequisite of workflow processing.

15. The product origination system as in claim 12, wherein the data capture attributes comprise a required for save dataset or a required for submit dataset.

16. The product origination system as in claim 12, wherein said at least two products are selected from the group of:
a gun license,
a hunting license,
a private investigator license,
an exterminator license,
a hair dresser license,
a real estate license,
a fishing license,
a dog license,
a credit product,
a deposit account,
an investment account,
an insurance policy,
utility provisioning, and
a wireless subscription.
